(19) United States
(12) Patent Application Publication
(10) Pub. No.: US 2016/0270156 A1
(43) Pub. Date: Sep. 15, 2016

(54) HEATING-WIRE FASTENING BASE, A HEATING-WIRE FASTENER AND A HEATING-WIRE FASTENING ASSEMBLY

(71) Applicant: Nanjing Yiqing Machinery Manufacturing Co., Ltd, Nanjing City (CN)

(72) Inventor: Zhenhai Zhang, Nanjing City (CN)

(73) Assignee: Nanjing Yiqing Machinery Manufacturing Co., Ltd

(21) Appl. No.: 14/696,610

(22) Filed: Apr. 27, 2015

(30) Foreign Application Priority Data
Mar. 11, 2015 (CN) 201510106608.7

(51) Int. Cl. H05B 3/06; H05B 3/02

(52) U.S. Cl. CPC H05B 3/06; H05B 3/02

(57) ABSTRACT

The present application discloses a heating-wire fastening base, a heating-wire fastening device and a heating-wire fastening assembly. The fastening base is provided with a heating-wire fastening groove at a first direction, and a fastening hole provided on the fastening base along a second direction which is unparallel with the first direction. The fastening hole is communicated with the heat-wire fastening groove. Thus, problems of difficult installation and lacking strength of assembly can be resolved, and advantageous effects are available, such as easy installation and disassembling, less time for operation, and low cost of manufacturing.

### FIELD OF THE INVENTION

The present application relates to the field of electrical heating, especially relating to a heating-wire fastening base, a heating-wire fastening device and a heating-wire fastening assembly.

### BACKGROUND OF THE INVENTION

A heating-wire fastening device is a part often used at the sealing bar of a vacuum packaging machine. As shown in FIG. 1, most of the conventional fasteners comprise an epoxy resin board 2 with one through hole 3 being provided at each of the two ends thereof. A path 4 is provided between each of the through holes and corresponding one of the two ends of the epoxy resin board 2 for passing a heating-wire 1. A fastening bolt 5 is installed in the path 4 for fastening the heating-wire. The fastening bolt 4 is a conventional bolt with a groove 51 at the screw portion, as shown in FIG. 2. The heating-wire 1 is inserted into the groove 51 of the fastening bolt 5 during operation, passes through the path 4 of the epoxy resin board 2, and then is tensioned and fixed by screwing the fastening bolt 5. The installation of such heating-wire fastening device is relatively complicated, and the whole fastening bolt 5 should be removed when the heating-wire fastening device is disassembled, which causes inconvenient use of the fastener.

### SUMMARY OF THE INVENTION

An object of the present invention is to provide a heating-wire fastening device that is easy to install and disassemble.

According to an aspect of the present invention, there is provided a heating-wire fastening base, wherein a heating-wire fastening groove is provided at a first direction on the base, and a fastening hole is formed at a second direction which is unparallel with the first direction of the heating-wire fastening groove, said fastening hole is in communication with the heating-wire fastening groove.

In some embodiments, said first direction is approximately vertical, said second direction is generally transversal.

In some embodiments, the lower end of the heating-wire fastening groove bends towards the second direction.

In some embodiments, the heating-wire fastening groove is a through groove.

In some embodiments, the heating-wire fastening groove has a cut of arc shape at the opening thereof.

In some embodiments, two or more fastening holes are provided.

In some embodiments, a heating-wire fastening groove is provided at the top of the fastening base.

According to another aspect of the invention, there is provided a heating-wire fastening device comprising a fastening base as discussed above and a fastener; the fastener being capable of assembling with and connected to the fastening hole so as to fix a heating-wire into the heating-wire fastening groove.

In some embodiments, both the fastener and the fastening hole are screwed.

According to another aspect of the invention, there is provided a heating-wire fastener assembly comprising a heating-wire fastener, an epoxy plate and a heating-wire, the heating-wire fastener being fixedly connected with two ends of the epoxy plate, and both ends of the heating-wire being assembled with the heating-wire fastening groove of the heating-wire fastener.

A fastening groove and a support member mounting hole are formed at a side of fastening base opposite to the fastening hole, so that the fastening base is fixedly connected to the epoxy plate.

According to the above aspects of the invention, various advantageous effects can be obtained, such as easy and less time for assembling and disassembling, not easy to be damaged, simple structure, and low cost of manufacturing. Furthermore, due to the metal structure at both ends of the fastening base of the invention, the service life of the heating-wire is significantly improved, rendering better economical effect.

Other objects, features and advantages of the invention should be apparent from the following description of embodiments thereof as illustrated in the accompanying drawing.

### BRIEF DESCRIPTION OF DRAWINGS

FIG. 1 schematically shows the structure of a fastener of the prior art;

FIG. 2 schematically shows a fastening bolt of the prior art;

FIG. 3 is a front view of a heating-wire fastening device in an embodiment of the invention;

FIG. 4 is a section view at longitudinal direction of an end of a heating-wire fastening device according to an embodiment of the invention;

FIG. 5 is a section view of a heating-wire fastening device after a heating-wire is installed therein according to an embodiment of the invention;

FIG. 6 is a front view of a heating-wire fastening device according to another embodiment of the invention;

FIG. 7 is a front view of a heating-wire fastening device according to a further embodiment of the invention;

FIG. 8 is a section view taken at longitudinal direction of an end portion of a heating-wire fastening device according to another embodiment of the invention;

FIG. 9 is a top view of the heating-wire fastening device according to the embodiment as shown in FIG. 8; and

FIG. 10 is a section view taken at longitudinal direction of a heating-wire fastening device after a heating-wire is installed according to another embodiment of the invention.

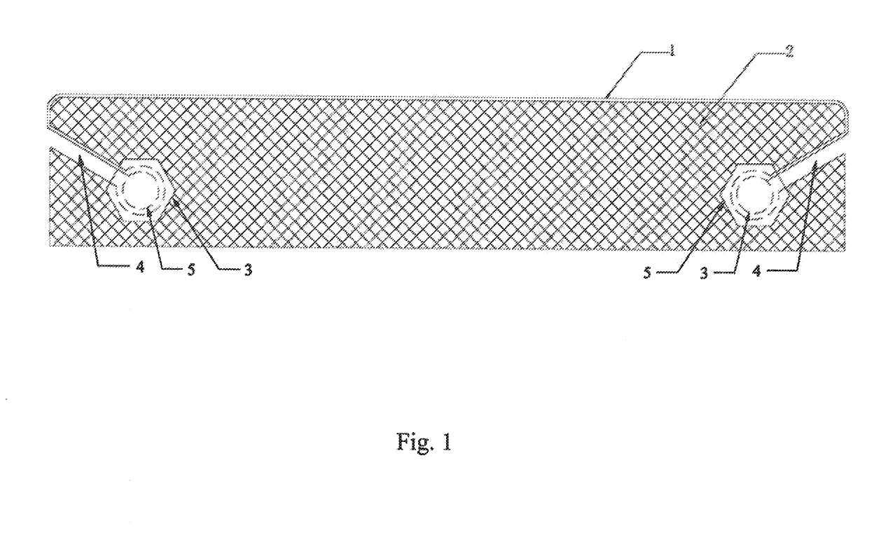

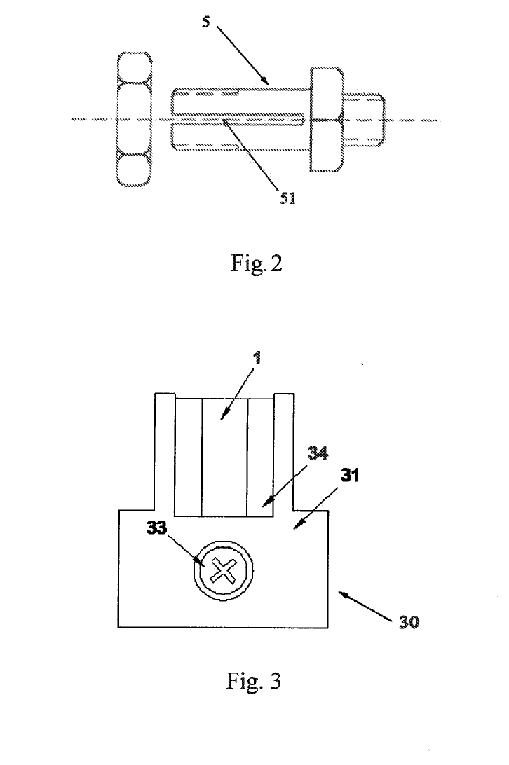

### DESCRIPTION OF THE PREFERRED EMBODIMENT

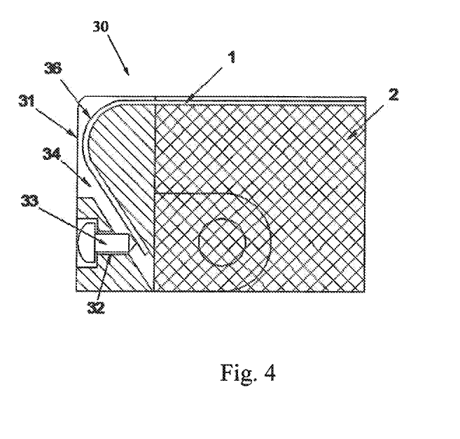

As shown in FIGS. 3 and 4, a heating-wire fastening device 30 according to an embodiment of the present invention comprises a fastening base 31 in which a heating-wire fastening groove 34 is formed at an approximately vertical direction. The heating-wire fastening groove 34 is a through groove of slot type, with its lower end bending in the fastening direction in which a fastener 33 moves within a fastening hole 32 so that the heating-wire is easy to be straightened and fastened. A fastening hole 32 is formed in a approximately transversal direction of the heating-wire fastening groove 34 and is communicated with the slant lower end of the heating-wire fastening groove 34. By arranging the direction of the fastening groove 34 and the direction of the fastening hole 32 (direction of fastening) in such a manner as mentioned above, the fastening hole 32 and the fastener 33 are assembled together so as to fasten the heating-wire within the heating-wire fastening groove 34. The above fastening hole 32 and the fastener 33 can be assembled together through various ways. For example, the fastening hole 32 can be a screw hole, and the fastener 33 can be a screw, a screw arbor or a bolt. Alternatively, the fastening hole 32 can be a pin hole, and the fastener 33 can be a pin.

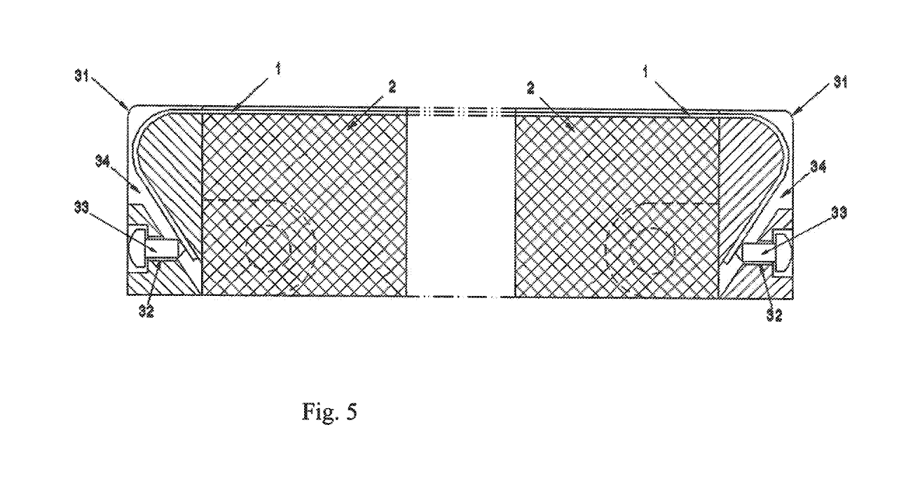

Referring to FIG. 5, during operation, the heating-wire fastening device 30 is firstly mounted at both ends of the epoxy resin board 2. The mounting of heating-wire 1 comprises two steps. Firstly, one end of the heating-wire 1 is inserted into a heating-wire fastening groove 34 at one side of the heating-wire fastening device 30 to place the end of the heating-wire 1 into the opening of the fastening hole 32, and then the fastener 33 is screwed into the fastening hole 32 to make the end of fastener 33 press onto the heating-wire 1 tightly, thus mounting the heating-wire 1 at one side. Secondly, another end of the heating-wire 1 is inserted into the heating-wire fastening groove 34 at another side of the heating-wire fastening device 30 and tensioned to be fixed in the heating-wire fastening groove 34 by screwing the fastener 33 to complete the mounting. The heating-wire 1 can be easily removed from the fastener 31 by just screwing the fastener 33 off the heating-wire 1 and then drawing out the heating-wire 1.

As shown in FIG. 4, to reduce damage occurring during fastening, the heating-wire fastening groove 34 has a cut 36 with an arc shaped opening, thereby improving life circle of heating-wire.

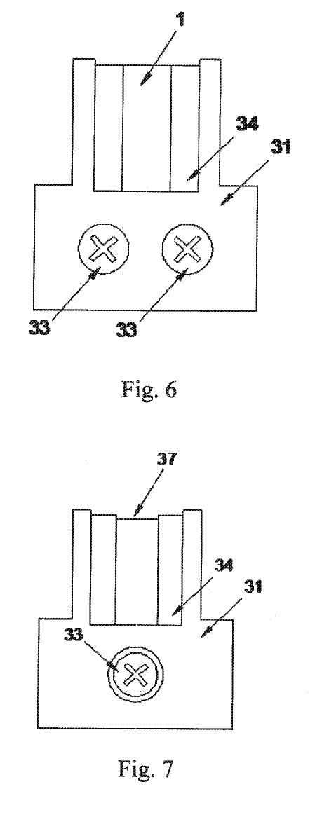

As shown in FIG. 6, in order to improve the strength of fastening of the heating-wire 1, two or more fastening holes 32 may be provided so as to improve the installation stability of the heating-wire 1, especially when the heating-wire 1 is in the shape of a strap for easy fastening thereof. Or, when a plurality of heating-wires are to be mounted, a single fastening hole 32 can be used for the fastening of a single heating-wire, and thus two fastening holes 32 can be used to fasten two heating-wires.

As shown in FIG. 7, to improve the precision of mounting the heating-wire and ensure a better straightness, the top of the fastening base 31 is provided with a heating-wire fastening groove 37. A heating-wire of strap shape can be directly fastened to the fastening groove 37 and a better stability in use is available.

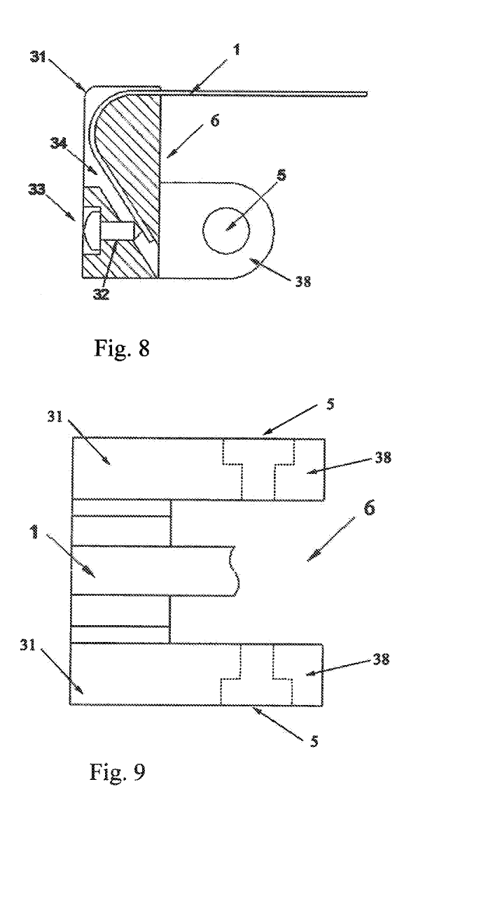

As shown in FIGS. 8 and 9, the fastening base 31 and the epoxy resin board 2 can be connected in many ways. To improve the stability of connection between the fastening base 31 and the epoxy resin board 2, the fixing side of the fastening base 31 is provided with a cavity 6 between two lugs 38 and a support element installation hole 5 on each of the lugs 38 so that the fastening base 31 can be fastened against the epoxy resin board 2 with connecting elements assembled with the support element installation hole 5.

The present invention also provides a heating-wire fastening assembly comprising a heating-wire fastening device 30, an epoxy resin board 2 and a heating-wire 1 as mentioned above. The heating-wire 1 is fixedly connected to two ends of the epoxy resin board 2. Both ends of the heating-wire 1 is installed within and fixedly connected to the heating-wire fastening groove 34 of the heating-wire fastening device.

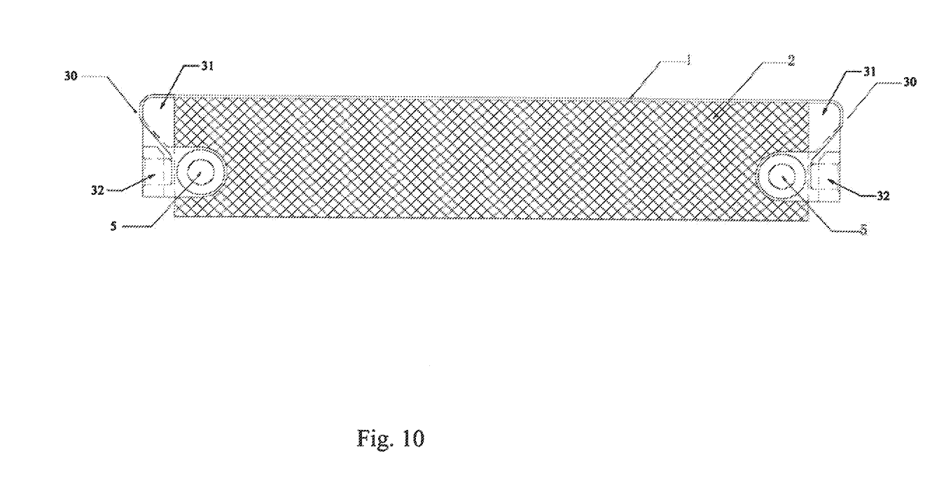

It should be noted that the insert end of the heating-wire 1 in the heating-wire fastening groove 34 can be fastened in various forms. For example, an end of heating-wire 1 can be fixed in heating-wire fastening groove 34 by fastener 33 as shown in FIG. 4, or fixed at a side of epoxy resin board 2 by fastener 33 as shown in FIG. 10.

According to the embodiments of the invention, a wire for power supply to the heating-wire 1 can be connected to either two ends or a side of the heating-wire fastening device 30. In an embodiment, the wire is connected with a bolt for fixing the heating-wire fastener 33.

Thus, according to the above embodiments, heating-wire fastening device 33 is installed tightly on the two ends of epoxy resin board 2, which is different from conventional heating-wire fastening devices that need to form a slant groove on the epoxy resin board which renders an adverse effect on the structure of the epoxy resin board. On the contrary, the above embodiments overcome this defect and thus improve the life cycle of the epoxy resin board 2. Furthermore, the heating-wire fastening device 33 of the above embodiments is fixed tightly at two ends of the epoxy resin board 2, which prevents aging of the two ends of the heating-wire due to the good heat conductivity of the metal material and thus improves the life circle of the heating-wire.

While the invention has been particularly shown and described with reference to embodiments, it should be understood by those skilled in the art that these embodiments are just for example and not intended for limiting the scope of the invention, and changes in form and detail may be made therein without departing from the spirit and scope of the invention.

What is claimed is:

1. A heating-wire fastening base, wherein a heating-wire fastening groove is formed at a first direction on the fastening base, and a fastening hole is formed in the fastening base at a second direction which is unparallel with the first direction, the fastening hole being communicated with the heating-wire fastening groove.

2. The heating-wire fastening base according to claim 1, wherein the lower end of the heating-wire fastening groove bends towards the second direction.

3. The heating-wire fastening base according to claim 2, wherein the heating-wire fastening groove is a through groove.

4. The heating-wire fastening base according to claim 1, wherein the heating-wire fastening groove has a cut of arc shape at the opening thereof.

5. The heating-wire fastening base according to claim 1, wherein the number of the fastening holes is two or more.

6. The heating-wire fastening base according to claim 1, wherein the first direction is approximately vertical, and the second direction is approximately transversal.

7. The heating-wire fastening base according to claim 1, wherein a heating-wire fastening groove is formed on the top of the fastening base.

8. A heating-wire fastening device, comprising a fastening base and a fastener according to claim 1, the fastener being assembled and connected with the fastening hole so that a heating-wire is fastened within the heating-wire fastening groove.

9. The heating-wire fastening device according to claim 8, wherein the fastener is a screw thread fastener assembled and connected with the fastening hole that is a screw hole.

10. The heating-wire fastening device according to claim 8, wherein the lower end of the heating-wire fastening groove bends towards the second direction.

11. The heating-wire fastening device according to claim 10, wherein the heating-wire fastening groove is a through groove.

12. The heating-wire fastening device according to claim 8, wherein the heating-wire fastening groove has a cut of arc shape at the opening thereof.

13. The heating-wire fastening device according to claim 8, wherein two or more fastening holes are provided.

14. The heating-wire fastening device according to claim 8, wherein the first direction is approximately vertical, and the second direction is approximately transversal.

15. The heating-wire fastening device according to claim 8, wherein a heating-wire fastening groove is formed on the top of the fastening base.

16. A heating-wire fastening assembly, comprising the heating-wire fastener device according to claim 8, an epoxy resin board and a heating-wire, wherein the heating-wire fastening device is fixedly connected at two ends of the epoxy resin board; and both ends of the heating-wire is assembled with and fixedly connected to the heating-wire fastening groove of the heating-wire fastening device.

17. The heating-wire fastening assembly according to claim 16, wherein the fastening groove and a support member mounting hole are formed at a side of the fastening base opposite to the fastening hole, so that the fastening base is fixedly connected to the epoxy plate.

18. The heating-wire fastening assembly according to claim 17, wherein the lower end of the heating-wire fastening groove bends towards the second direction.

19. The heating-wire fastening assembly according to claim 18, wherein the heating-wire fastening groove is a through groove.

20. The heating-wire fastening assembly according to claim 17, wherein a heating-wire fastening groove is formed on the top of the fastening base.
